(19) United States
(12) Patent Application Publication
(10) Pub. No.: US 2026/0195604 A1
(43) Pub. Date: Jul. 9, 2026

(54) SEMI-AUTOMATED GENERATIVE AGENT

(71) Applicant: ASAPP, INC., New York, NY (US)

(72) Inventors: Kilian Quirin Weinberger, Ithaca, NY (US); Santiago de Buen, New York, NY (US); Michael Griffiths, Brooklyn, NY (US); Satchuthananthavale Rasiah Kuhan Branavan, Caterham (GB); Paloma Sodhi, Ithaca, NY (US); Soham Ray, Ithaca, NY (US); Volkan Cirik, London (GB); Hashan Buddhika Narangodage, Jersey City, NJ (US)

(21) Appl. No.: 19/382,536

(22) Filed: Nov. 7, 2025

Related U.S. Application Data
(60) Provisional application No. 63/741,557, filed on Jan. 3, 2025.

(51) Int. Cl. G06N 3/091; G06N 3/0475

(52) U.S. Cl. CPC G06N 3/091; G06N 3/0475

(57) ABSTRACT

The performance of a generative agent (GA) is improved using live interactions. A conversation between a user and the GA is monitored while the GA produces responses from one or more pre-trained models. For each GA response, the system computes a quality score and compares it to a predefined threshold. When the score fails to satisfy the threshold, the response is automatically flagged, the session is paused, and the flagged response is withheld from presentation to the user. An intervention interface is then presented that enables a human agent to modify the flagged response.

### CLAIM OF PRIORITY

This patent application claims the benefit of U.S. patent application Ser. No. 63/741,557, filed Jan. 3, 2025, and entitled “SEMI-AUTOMATED GENERATIVE AGENT (SAGA)” (ASAP-0054-P01).

The content of the foregoing application is hereby incorporated by reference in its entirety for all purposes.

### BACKGROUND

Autonomous conversational agents often exhibit unpredictable behaviors, hallucinations, or misinterpretations when responding to user messages. Traditional chatbots either rely on rigid templates or demand extensive manual curation, limiting scalability and adaptability to new intents. As a result, many deployments lack mechanisms to detect and intercept low-quality outputs before they reach the user. Static pre-deployment training further fails to accommodate evolving policies, tools, or customer contexts, leading to persistent error patterns and diminished trust in automated interactions.

### SUMMARY

In some aspects, the techniques described herein relate to a method for improving performance of a generative agent during live interactions, the method including: monitoring a conversation between a user and the generative agent, wherein the generative agent generates responses based on pre-trained models; analyzing a first response generated by the generative agent to determine a first response quality score; automatically flagging the first response for human intervention based on a quality score threshold; pausing the conversation upon flagging the first response for intervention, wherein the pause prevents the flagged response from being presented to the user; enabling a human agent to modify the flagged response through an intervention interface, wherein the intervention interface allows the human agent to act as the generative agent by interacting with tools accessible to the generative agent; updating the conversation with the modified response generated by the human agent; resuming the conversation after the modified response is presented to the user; and recording the flagged response, the human intervention, and the modified response as corrective data for training the generative agent to improve future response generation.

In some aspects, the techniques described herein relate to a method, wherein the intervention interface visually distinguishes flagged responses for intervention from other responses with visual emphasis.

In some aspects, the techniques described herein relate to a method, further including dynamically adjusting the response quality score threshold based on at least one of: system resource availability, human agent availability, or conversation urgency indicators.

In some aspects, the techniques described herein relate to a method, wherein the flagged response includes pre-responses generated by the generative agent, and the human agent is enabled to modify the pre-responses before they result in customer-facing actions.

In some aspects, the techniques described herein relate to a method, further including categorizing flagged responses into critical and non-critical types, wherein critical responses are prioritized for intervention under high-load conditions.

In some aspects, the techniques described herein relate to a method, wherein the corrective data recorded includes metadata describing a reason for the human intervention and a context of the conversation.

In some aspects, the techniques described herein relate to a method, further including presenting metrics of intervention frequency and types to a dashboard for monitoring the generative agent's performance over time.

In some aspects, the techniques described herein relate to a method, wherein the intervention interface translates machine-readable outputs into human-readable formats to facilitate human agent interaction.

In some aspects, the techniques described herein relate to a method, further including enabling the human agent to initiate API calls through the intervention interface, wherein the API calls are formatted to match a syntax used by the generative agent.

In some aspects, the techniques described herein relate to a method, wherein the generative agent is retrained periodically using the corrective data recorded from human interventions to improve response generation accuracy.

In some aspects, the techniques described herein relate to a method, further including: monitoring multiple conversations between users and the generative agent; analyzing performance metrics across the monitored conversations, including intervention frequency, response quality scores, and types of flagged responses; and dynamically updating a graphical display to present aggregated performance metrics.

In some aspects, the techniques described herein relate to a method, wherein the intervention interface provides real-time suggestions to the human agent for modifying flagged responses.

In some aspects, the techniques described herein relate to a system, including at least one server computer including at least one processor and at least one memory, the at least one server computer configured to: monitor a conversation between a user and a generative agent, wherein the generative agent generates responses based on pre-trained models; analyze a first response generated by the generative agent to determine a first response quality score; automatically flag the first response for human intervention based on a quality score threshold; pause the conversation upon flagging the first response for intervention, wherein the pause prevents the flagged response from being presented to the user; modify the flagged response through an intervention interface, wherein the intervention interface allows the human agent to act as the generative agent by interacting with tools accessible to the generative agent; update the conversation with the modified response generated by the human agent; resume the conversation after the modified response is presented to the user; and record the flagged response, the human intervention, and the modified response as corrective data for training the generative agent to improve future response generation.

In some aspects, the techniques described herein relate to one or more non-transitory, computer-readable media including computer-executable instructions that, when executed, cause at least one processor to perform actions including: monitoring a conversation between a user and a generative agent, wherein the generative agent generates responses based on pre-trained models; analyzing a first response generated by the generative agent to determine a first response quality score; automatically flagging the first response for human intervention based on a quality score threshold; pausing the conversation upon flagging the first response for intervention, wherein the pause prevents the flagged response from being presented to the user; enabling a human agent to modify the flagged response through an intervention interface, wherein the intervention interface allows the human agent to act as the generative agent by interacting with tools accessible to the generative agent; updating the conversation with the modified response generated by the human agent; resuming the conversation after the modified response is presented to the user; and recording the flagged response, the human intervention, and the modified response as corrective data for training the generative agent to improve future response generation.

In some aspects, the techniques described herein relate to a method for improving performance of a generative agent through counterfactual data collection, the method including: receiving a plurality of conversations between users and the generative agent, wherein the generative agent generates responses based on pre-trained models; identifying responses within the conversations based on a quality threshold; flagging the identified responses for intervention and recording the flagged responses along with their associated conversation context; enabling a human agent to modify the flagged responses through an intervention interface; recording a human-modified response and the associated conversation context as corrective data; generating counterfactual conversation branches based on the human-modified responses, wherein each branch represents an alternative conversation path that would have occurred if the generative agent had initially provided the modified response; simulating the counterfactual conversation branches to evaluate their impact on conversation outcomes; identifying patterns of errors in the generative agent's response generation based on a counterfactual conversation analysis; and creating training data sets incorporating the flagged responses, the human-modified responses, and the counterfactual conversation branches.

In some aspects, the techniques described herein relate to a method, wherein the counterfactual conversation branches are generated by simulating alternative user responses based on the modified generative agent responses.

In some aspects, the techniques described herein relate to a method, further including categorizing the flagged responses and counterfactual conversation branches into error types, wherein the error types include at least one of contextual misunderstanding, incorrect factual information, or inappropriate tone.

In some aspects, the techniques described herein relate to a method, wherein the simulation of counterfactual conversation branches includes evaluating conversation outcomes using a success metric, wherein the success metric includes at least one of a user satisfaction score or task completion rate.

In some aspects, the techniques described herein relate to a method, further including weighting the counterfactual conversation branches based on their likelihood of improving future generative agent responses.

In some aspects, the techniques described herein relate to a method, wherein the corrective data recorded includes metadata describing a reason for the human intervention, a timestamp of the intervention, and a conversation context.

In some aspects, the techniques described herein relate to a method, further including presenting aggregated metrics of counterfactual conversation analysis, including error frequency and success rates, to a dashboard for monitoring generative agent performance.

In some aspects, the techniques described herein relate to a method, further including dynamically adjusting the quality threshold for flagging responses based on conversation context factors, including user account priority level, conversation urgency indicators, or topic sensitivity classification.

In some aspects, the techniques described herein relate to a method, wherein the counterfactual conversation branches are used to generate contrastive examples for training the generative agent, highlighting differences between successful and unsuccessful conversation paths.

In some aspects, the techniques described herein relate to a method, further including retraining the generative agent periodically using the training data sets created from flagged responses, human-modified responses, and counterfactual conversation branches.

In some aspects, the techniques described herein relate to a method, wherein the counterfactual conversation branches are generated using a customer simulator that replicates user behavior based on historical conversation data.

In some aspects, the techniques described herein relate to a system, including at least one server computer including at least one processor and at least one memory, the at least one server computer configured to: receive a plurality of conversations between users and a generative agent, wherein the generative agent generates responses based on pre-trained models; identify responses within the conversations based on a quality threshold; flag the identified responses for intervention and recording the flagged responses along with their associated conversation context; modify the flagged responses through an intervention interface; record a human-modified response and the associated conversation context as corrective data; generate counterfactual conversation branches based on the human-modified responses, wherein each branch represents an alternative conversation path that would have occurred if the generative agent had initially provided the modified response; simulate the counterfactual conversation branches to evaluate their impact on conversation outcomes; identify patterns of errors in the generative agent's response generation based on a counterfactual conversation analysis; and create training data sets incorporating the flagged responses, the human-modified responses, and the counterfactual conversation branches.

In some aspects, the techniques described herein relate to one or more non-transitory, computer-readable media including computer-executable instructions that, when executed, cause at least one processor to perform actions including: receiving a plurality of conversations between users and a generative agent, wherein the generative agent generates responses based on pre-trained models; identifying responses within the conversations based on a quality threshold; flagging the identified responses for intervention and recording the flagged responses along with their associated conversation context; enabling a human agent to modify the flagged responses through an intervention interface; recording a human-modified response and the associated conversation context as corrective data; generating counterfactual conversation branches based on the human-modified responses, wherein each branch represents an alternative conversation path that would have occurred if the generative agent had initially provided the modified response; simulating the counterfactual conversation branches to evaluate their impact on conversation outcomes; identifying patterns of errors in the generative agent's response generation based on a counterfactual conversation analysis; and creating training data sets incorporating the flagged responses, the human-modified responses, and the counterfactual conversation branches.

### BRIEF DESCRIPTION OF THE FIGURES

The invention and the following detailed description of certain embodiments thereof may be understood by reference to the following figures:

FIG. 1 illustrates aspects of a training and adaptation lifecycle for a generative agent.

FIG. 2 is an example system for providing automated customer support using a generative model.

FIG. 3 depicts aspects of the changes in operating configurations of a system, illustrating how the system transitions through different phases over time.

FIG. 4 illustrates a flowchart of an example method for improving the performance of a generative agent during live interactions.

FIG. 5 illustrates aspects of an example conversation console.

FIG. 6A depicts an example saved conversation that may be used to generate a number of training examples.

FIG. 6B shows one example of a tree of counterfactuals.

FIG. 7 illustrates a flowchart of an example method for improving the performance of a generative agent through counterfactual data collection and analysis.

### DETAILED DESCRIPTION

Automated customer service platforms may incorporate generative agents (“GAs”) configured to autonomously conduct interactions with customers, generate responses, and perform service-related tasks based on pre-trained machine learning models. Although such GAs provide efficiencies in scaling customer interactions, their reliability and accuracy remain problematic. Customers frequently experience circumstances in which the GA furnishes incorrect information, produces contextually inappropriate responses, or fails to properly interpret the conversation context.

Conventional approaches for improving GA performance have relied primarily on extensive pre-deployment training using large datasets. While such training may improve baseline performance, it fails to account for the dynamic and evolving nature of real-world customer interactions. Moreover, once deployed, many existing systems lack effective mechanisms for ongoing correction, feedback incorporation, and adaptation. As a result, errors and inefficiencies may persist over time without resolution.

In contrast, embodiments described herein introduce a hybrid operational framework wherein a GA continues to autonomously manage interactions, but a human agent remains responsible for supervisory oversight and intervention. This oversight is beneficial during an initial onboarding phase, in which the human agent actively monitors GA-customer exchanges to ensure reliable and accurate performance. During this onboarding period (spanning from a single day to several weeks or months, depending on task complexity), the human agent may selectively intervene to correct GA errors, thereby guiding the GA toward improved operational accuracy and customer satisfaction.

In embodiments, the interactions between the generative agent and human supervisors during live operation may be used to improve a pre-trained GA model to advance subsequent autonomous performance. During supervised sessions, conversation turns can generate structured data pairs comprising the GA's original output and the corresponding human-corrected or approved output. These pairs, together with contextual information (e.g., conversation metadata, intervention reason codes, and quality scores), may be used as learning examples that may be aggregated across sessions. The resulting dataset may be used to improve the pre-trained model.

For the purpose of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

A generative agent, as used herein, should be understood broadly. In embodiments, a generative agent may comprise or utilize a language model, together with additional control logic and interfaces, to autonomously process inputs and determine actions in the context of a customer support session. In some embodiments, the generative agent may be a multimodal model trained to interpret and generate information across multiple modalities, such as text, audio, and visual data. The generative agent may therefore operate not only on textual exchanges but also on spoken utterances, images, videos, or other sensory inputs relevant to a user interaction. In certain configurations, the model may be pre-trained directly on multimodal datasets that couple linguistic, auditory, and visual representations (e.g., aligning speech or image features with corresponding textual descriptions). In other embodiments, the generative agent may interface with one or more auxiliary models (e.g., automatic speech recognition, text-to-speech, or computer-vision components) that perform modality-specific encoding and decoding. The generative agent may reason jointly over multimodal information, apply cross-modal grounding to improve contextual understanding, and generate coordinated responses across modalities.

In embodiments, multimodal capability can be achieved without requiring explicit alignment between modalities. Embodiments may employ a unified transformer or sequence model that can ingest and process tokens from different modalities in a common representational space. In some cases, encoders may be used which produce embeddings that share a common dimensionality such that the model to process text, image, or audio content as interchangeable streams of tokens within the same attention layers. In one example, visual inputs such as images or video frames may be “tokenized” by dividing each image into small, fixed-size patches, flattening those patches into vectors, and projecting them into the same embedding dimension used for textual tokens. The projected patch embeddings may be then concatenated with text embeddings and fed directly into the model's transformer layers, permitting a single attention mechanism to operate jointly over both visual and textual content. Similar strategies can be applied to other modalities such as audio, where waveform segments or spectrogram patches are likewise represented as tokens. In embodiments, any methods for processing multiple modalities may be used.

The GA models described herein may be pre-trained models. Pre-training, as used herein, refers to an initial stage in which a model is trained on a large corpus of heterogeneous data that may span multiple domains. Pre-training enables the model to learn patterns, including linguistic, perceptual, and/or reasoning patterns. Models are typically pre-trained to establish general-purpose representational capabilities across diverse topics and interaction types. Prior to deployment within a generative agent framework, these pre-trained models may be fine-tuned using domain-specific datasets or task-oriented objectives to adapt their behavior to particular operational environments (for example, historical human customer service conversations and/or historical human conversations from the relevant domain).

In many cases, pre-deployment fine-tuning may be time-consuming, computationally expensive, or inadequate to capture the full range of dynamic conditions that arise during real-world operation. Even when domain-specific fine-tuning is performed before deployment, unforeseen conversational contexts, evolving policies, or new customer intents may expose limitations in the model's adapted behavior. Accordingly, embodiments of the present disclosure address these challenges by enabling ongoing or incremental refinement of the generative agent through live supervision, corrective feedback, and post-deployment adaptation. Such adaptive fine-tuning allows the model to evolve based on real interaction data, improving robustness and responsiveness without the need for repeated full retraining cycles.

Corrective data or feedback collected from CSRs during supervised or semi-supervised interactions may be used to fine-tune the generative agent models. The CSR feedback data, which includes pairs of original and corrected responses, contextual metadata, and intervention reasons, provides a direct signal of human-preferred behavior. The feedback data may be aggregated into supervised training sets or preference-pair datasets for reinforcement learning from human feedback. Incorporation of CSR feedback into fine-tuning cycles allows the generative agent to adapt to emerging service requirements and maintain alignment with operational and policy standards.

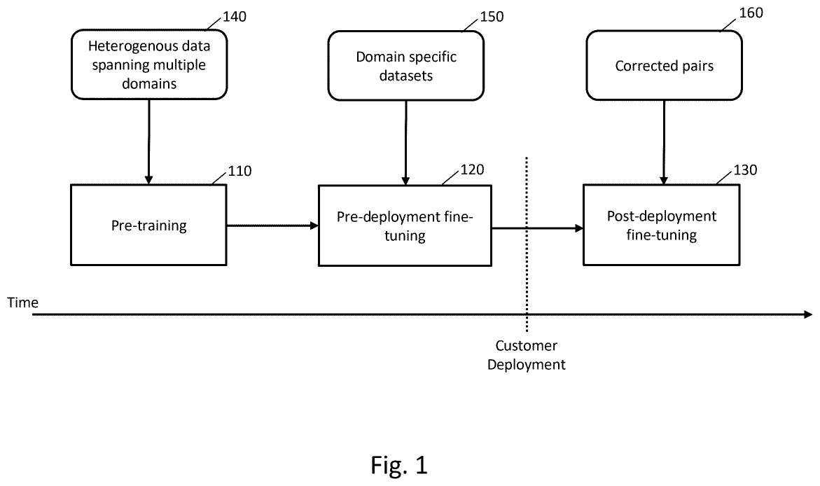

FIG. 1 illustrates an example training and adaptation lifecycle for a GA. Training of a GA may progress through three phases: a pre-training phase 110, a pre-deployment fine-tuning phase 120, and a post-deployment fine-tuning phase 130. The horizontal axis represents time, and the dashed vertical line labeled Customer Deployment marks the transition between pre-deployment and post-deployment operations.

During the pre-training phase 110, the model may be trained on heterogeneous data spanning multiple domains 140. This broad corpus may include publicly available text, audio, image, or multimodal datasets and serves to train the model with general-purpose representational and reasoning capabilities. Pre-training may employ unsupervised or self-supervised objectives, such as next-token prediction, masked-token reconstruction, or diffusion-based denoising, to capture linguistic and semantic patterns across diverse topics and modalities.

Following pre-training, the model may undergo a pre-deployment fine-tuning phase 120 using domain-specific datasets 150 that reflect the target operational environment. In the customer-support context, such datasets may include historical conversation transcripts, tool-usage logs, and policy-compliance examples. This stage may be used to align the model's behavior with task-specific conventions, vocabulary, and procedural rules relevant to the intended deployment.

After customer deployment, the model may continue to evolve through a post-deployment fine-tuning phase 130, which integrates corrected pairs 160 obtained from live or supervised interactions. These pairs typically consist of the model's original outputs and the corresponding human-corrected versions generated through an intervention interface, together with contextual metadata such as timestamps, reason codes, and conversation states. The corrected pairs may be periodically aggregated and used to further fine-tune the deployed model, enabling adaptation to new policies, tools, and conversational patterns observed in production.

Although many of the embodiments described herein are illustrated in the context of customer-company interactions, where a first user represents a customer and a second user represents a customer-service representative (CSR) or supervisor, the systems and methods disclosed are not limited to this domain. In general, the generative-agent framework may be applied to any environment in which automated or semi-automated communication occurs between distinct classes of participants having differentiated roles, permissions, or objectives. For example, the first user may be an individual or organization seeking information, authorization, validation, or assistance from an entity that may be commercial, financial, governmental, educational, legal, healthcare-related, or otherwise institutional or organizational in nature. Likewise, the second user may represent any form of oversight, review, or supervisory function appropriate to the given context, such as a subject-matter expert, policy reviewer, compliance officer, quality-assurance auditor, adjudicator, or regulator charged with maintaining adherence to standards or protocols. The underlying data structures, intervention interfaces, and feedback mechanisms described herein may be repurposed to facilitate adaptive oversight and continuous improvement in a wide variety of communication and decision-making workflows.

By way of example, in a healthcare environment, a generative agent may engage directly with patients or clinical staff to triage medical inquiries, schedule appointments, or summarize visit notes, while a licensed clinician or care coordinator supervises the agent's responses for clinical accuracy and compliance with privacy regulations such as HIPAA. In a governmental or administrative setting, the generative agent may assist applicants in completing forms or navigating regulatory requirements, with oversight provided by an agency reviewer or case worker who validates the agent's recommendations and intervenes where nuanced interpretation of policy is required. In a legal or financial compliance workflow, the agent may draft disclosures, evaluate contract terms, or respond to routine regulatory inquiries, subject to supervision by an attorney, compliance analyst, or auditor who verifies factual statements and ensures conformity with statutory standards.

In educational environments, the GA may operate between students and instructional platforms, wherein a generative agent provides tutoring, grading, or feedback services and a supervising educator reviews interventions, refining the model's instructional style or accuracy over time. In enterprise knowledge-management or research-analysis contexts, a first user may represent an employee, researcher, or client issuing information-retrieval requests, while the supervisory counterpart represents an internal expert, reviewer, or manager who oversees the correctness and sensitivity of the responses. Similarly, in industrial or technical-support applications, the agent may assist technicians in diagnosing equipment faults or configuring systems, with supervision provided by an engineer or safety officer to ensure that recommended actions align with operational protocols.

More generally, the disclosed generative-agent architecture supports any multi-party communication workflow that benefits from adaptive automation combined with human oversight. The framework's modular design allows organizations to deploy it in heterogeneous environments. Thus, while the customer-support example provides a concrete illustration of the architecture, the same principles extend broadly across sectors in which accuracy, accountability, and evolving policy alignment are useful.

During operation in customer service interactions, the generative agent may be provided with information relating to a customer support request. Such information may include, in any combination, (i) communications exchanged between the customer and the system during the support session (e.g., text, images, voice recordings); (ii) a list of application programming interface (API) calls that are available to be performed to assist in resolving the support request; (iii) corresponding API calls previously invoked in the session (e.g., text of API calls, binary API calls, etc.); (iv) responses received from such API calls (e.g., text, images, webpages, audio, etc.); and (v) instructions indicating how the foregoing information is to be processed in order to determine a next action for the session (e.g., identifying an API call to be performed or generating a communication to be transmitted to the customer).

While the present disclosure is described primarily in connection with text-based modalities for purposes of clarity, it should be understood that the same principles apply to other modalities as well. The foregoing data and conversations may encompass, without limitation, audio, and video content, including speech waveforms and transcripts, images, video frames, etc. Accordingly, even where examples are described herein using textual exchanges, the underlying architectures, training processes, and control logic are equally applicable to multimodal interactions involving auditory or visual information.

The information provided to the generative agent may be formatted as a prompt. The generative agent may analyze the prompt in view of its pre-trained models and contextual session data to produce output text or structured directives. The output may include natural language content intended for customer-facing communication, structured actions corresponding to specific API calls, or hybrid outputs that combine explanatory narrative with machine-readable commands. The generative agent's output may be processed by supporting components of the system. For example, natural language portions may be delivered to the customer via a user interface, while structured command portions may be parsed and used to automatically invoke corresponding API calls.

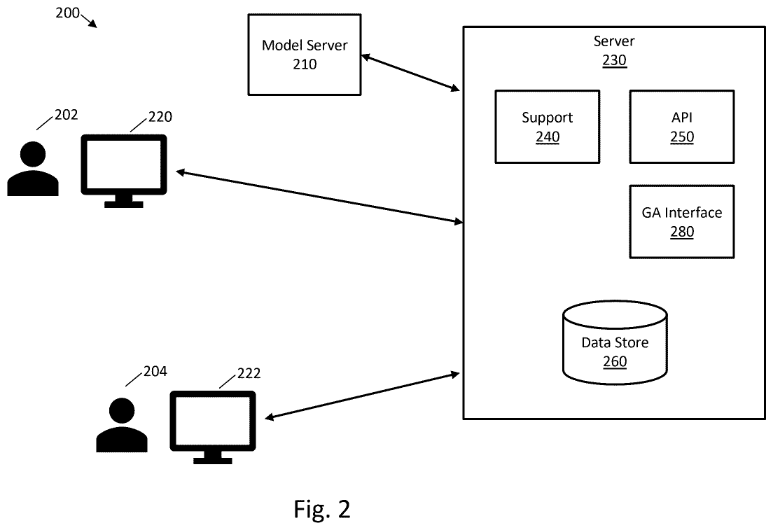

FIG. 2 illustrates an example system 200 that can be used to provide automated customer support through a generative agent. In FIG. 2, user 202 may use device 220 to obtain support from a company. Device 220 may be any appropriate device, such as a computer, tablet, conventional phone, or smartphone. User 202 may communicate the support request using any appropriate techniques, such as any combination of text, speech, or video. The support request may be transmitted over any appropriate network, such as a cellular network or the Internet.

The support request may be received at server 230. Server 230 may be implemented by a company or a third party and may be implemented using any appropriate techniques, such as cloud computing, and may include multiple server computers.

Server 230 may include various components. Support component 240 may perform any appropriate operations, such as receiving communications from a user, creating a support session, interacting with other components of server 230, and providing a responsive communication to the user. API component 250 may perform any appropriate API calls to assist with a customer support request, such as to retrieve information relating to the request or to perform actions relating to the request.

GA model interface 280 may facilitate sending prompts to a GA model and receiving responses from the GA model. GA model interface 280 may use any appropriate GA, such as a model component on server 230 (not shown) or a model available in another location, such as model server 210. A generative agent can be used to provide customer service by autonomously engaging in conversations with customers, answering questions, resolving issues, and performing tasks such as making API calls to access relevant information. The agent may interpret customer messages, generate appropriate responses, and execute actions like booking tickets or checking account status.

GA server 210 may be a server that receives a model prompt (e.g., a language model prompt), processes the prompt with a model to generate a response, and returns the model response to the requester. GA server 210 may be implemented using any appropriate techniques. For example, GA server 210 may receive model API calls and return model API call responses. In some implementations, GA model server 210 may be operated by a third party that is different from the company that operates server 230. In some implementations, GA server 210 may be operated by the company that operates server 230.

A second user 204, typically a customer support representative (CSR), may use device 222 to oversee an automated generative agent by monitoring its interactions with customers in real time through a dedicated interface. The GA may compose responses and perform actions, such as making API calls, while the CSR observes the interactions. If the agent makes a mistake or produces an unsatisfactory response, the CSR can intervene by editing the agent's output before it is sent to the customer. The interface may allow the CSR to pause the conversation, edit specific items, and restart the agent's process from the point of intervention. The CSR can oversee multiple concurrent conversations, aided by visual indicators or status boards that highlight which conversations may require attention.

Data store 260 may store any appropriate information to be used during the support request, such as information about the user or information about products and services of the company. Data store 260 may further include records of conversations between users and automated agents, as well as any corrections or interventions made by CSR during those interactions. These stored conversations may comprise both the original utterances generated by the automated agent and the corresponding corrected utterances provided by the human agent.

In embodiments where the generative agent operates across multiple modalities, such corrections may take different forms depending on the modality involved. For instance, in text-based interactions, a correction may involve editing or replacing portions of generated text; in audio-based exchanges, the correction may include adjusting tone, phrasing, or synthesized speech output; and in image- or video-based interactions, the correction may involve selecting alternative visual elements, modifying annotations, or replacing generated frames. Each modality-specific correction may be stored along with contextual metadata describing the nature of the intervention, the affected modality, and the reason for correction, thereby enabling fine-tuned adaptation of the generative agent across text, audio, and visual channels.

In embodiments, the system 200 may have various operating configurations. One embodiment allows the generative agent to run autonomously, handling user interactions and support requests without direct human oversight. In this configuration, the generative agent is responsible for generating responses, executing API calls, and managing the flow of the conversation based on its training and available data. In another embodiment, the generative agent may operate under supervision, wherein a human agent monitors the conversation and has the ability to intervene as needed. In this supervised mode, the human agent may review the generative agent's proposed utterances, outputs, or actions before they are presented to the user, and may modify, approve, or replace them to ensure accuracy and appropriateness.

In some embodiments, the system 200 may include an operating configuration where the system initiates operations with the generative agent in supervised mode and gradually transitions to unsupervised mode as the agent's performance improves. During the initial deployment phase, a human agent may monitor the generative agent's interactions, reviewing and, when necessary, correcting its responses and actions. This onboarding period may span from a single day to several weeks or months, depending on the complexity of the support tasks and the requirements of the organization.

As the generative agent demonstrates increased accuracy and consistency in handling support requests, the frequency and extent of human interventions may decrease. The system may track metrics such as the number of utterances between interventions or the rate of successful autonomous resolutions to assess the agent's readiness for reduced supervision. Over time, the system may automatically adjust the level of oversight, allowing the generative agent to operate with greater autonomy for routine or well-understood scenarios, while still providing mechanisms for escalation to human supervision in cases of uncertainty or elevated risk.

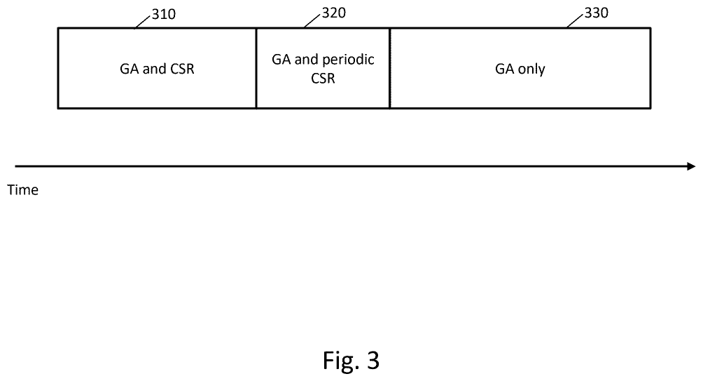

FIG. 3 depicts aspects of the changes in operating configurations of a system, illustrating how the system transitions through different phases over time. When a generative agent model is first deployed, the system may be operated in an onboarding phase 310. During this phase, a customer support representative actively supervises the generative agent, monitoring its interactions with users and intervening as necessary to correct errors and ensure appropriate responses.

During the onboarding phase 310, the corrections and CSR feedback may be used to fine-tune the GA. The interventions from the CSR may be systematically recorded, along with the original GA outputs and the corresponding corrected versions. The collected data, which includes both the unaltered outputs from the GA and the human-provided corrections, is used for fine-tuning the GA by analyzing the paired examples. The corrective feedback enables the GA to adapt its behavior, improve its accuracy, and better align with organizational standards and customer expectations. Over time, incorporating CSR feedback during the onboarding phase facilitates the refinement of the GA's underlying models, reducing the frequency of errors, and enhancing the overall quality of automated support.

Following the onboarding phase, the system may enter one or more optional transition phases 320. In these transition phases, the level of human supervision may be gradually reduced as the generative agent demonstrates improved performance and reliability. The system may employ various metrics, such as the frequency of interventions or the success rate of autonomous resolutions, to determine the appropriate timing and extent of supervision reduction. These transition phases provide a controlled environment in which the generative agent can continue to learn from corrective feedback while progressively assuming greater responsibility for managing user interactions.

After the training and adaptation process is complete, the system may enter phase 330, in which the system operates in a fully autonomous mode. In this phase, the generative agent may independently handle support requests, generate responses, and perform necessary actions without direct human oversight. In some cases, the system may retain mechanisms for escalation to human supervision in exceptional cases.

In certain embodiments, the system may be configured to manage a plurality of customer support conversations in parallel, with each conversation operating at a respective stage of autonomy. For example, a first conversation may be fully automated, wherein the generative agent independently interprets customer inputs, generates responses, and invokes associated actions without human intervention. At the same time, a second conversation may be operating in a partially supervised mode, wherein the generative agent generates candidate outputs, but a human supervisor reviews and approves the outputs prior to their delivery to the customer or execution as service actions. A third conversation may be conducted in a training or onboarding mode, in which the generative agent's outputs are monitored, corrected, and fed back into the system for adaptation.

The system may dynamically assign each active conversation to an autonomy stage. This system may track context, customer profile information, error histories, or business rules to determine whether a given conversation should remain fully autonomous, escalate to partial oversight, or revert to direct human handling. In some cases, transitions between autonomy stages may occur during the course of a single conversation, such as when the generative agent encounters an unfamiliar request, produces an output that triggers a confidence threshold alert, or receives negative feedback from the customer.

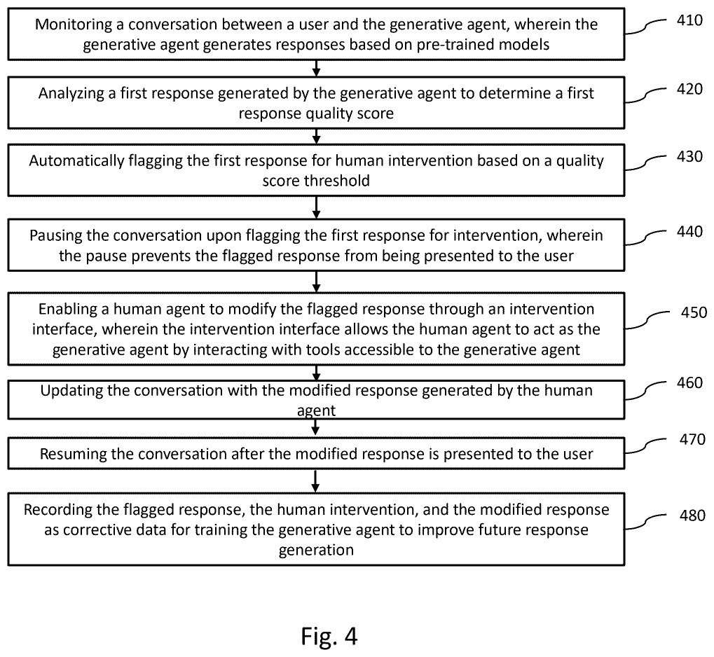

FIG. 4 illustrates a flowchart of an example method for improving the performance of a generative agent during live interactions.

At step 410, the method may include monitoring an ongoing conversation between a user and a generative agent that generates responses from one or more pre-trained models. In some embodiments, the monitoring may extend across multiple concurrent conversations, capturing per-session metrics such as intervention frequency, response quality scores, and types of flags.

At step 420, upon generation of a first response, the method may include analyzing the response to compute a quality score using metrics such as factuality, policy compliance, tool-parameter validity, and contextual coherence. During monitoring and analyzing, a quality-score threshold may be adjusted in view of system resource availability, human agent availability, and conversation urgency indicators (e.g., impending financial transactions or policy-sensitive topics). In certain embodiments, the response analyzed may include pre-responses (e.g., draft utterances, planned tool calls, intermediate rationales) that precede customer-visible output. The pre-responses (also referred to herein as “thoughts”) can be inspected to identify issues before they trigger customer-facing actions. Computed scores may be added to the per-conversation metric set used for cross-session analysis.

At step 430, the method may include comparing the quality score to the current (possibly dynamically adjusted) threshold. If unmet, the response is automatically flagged for human intervention at step 430. Flagging may also include categorization into critical and non-critical types (e.g., high-risk charges vs. informational replies) so that under some conditions (e.g., under high load), items are prioritized to the front of the agent's queue.

At step 440, when flagged, the conversation may be paused, preventing presentation of the flagged output to the user and holding any queued tool/API invocation. Where the flagged content includes pre-responses, those items are paused pre-commit so the human can edit them before they become customer-visible or execute on back-end systems.

At step 450, an intervention interface may be presented to the CSR. The interface may visually highlight the flagged conversation portions and translate machine-readable content (e.g., tool names, schemas, and parameters) into human-readable forms with validation hints. In some embodiments, the interface may include real-time suggestions proposing edits, safer phrasings, or alternative API calls based on policy and historical corrections.

At step 460, the CSR may modify the flagged response directly within the interface. When actions are required, the agent may initiate API calls through the same pathway and syntax used by the generative agent, including structured parameters and tool selection. The corrective data may be recorded to capture the original candidate, the modified version, metadata describing the reason for the intervention, and/or the conversational context. Edits may include changes to pre-responses guided by real-time suggestions.

At step 470, the method may include updating the conversation state with the human-modified response and replacing any pending tool actions with the edited equivalents. The corrective data (which may include reasons and context) is stored in a training/analytics store. The update pipeline also emits structured events that feed a dashboard aggregating intervention counts, categories (critical/non-critical), and score distributions.

At step 480, the modified response may be delivered to the user, and normal operation may resume. Post-delivery, the dashboard may dynamically update to reflect shifts in intervention frequency, quality scores, and flag types. Periodically, or on a schedule, the generative agent may be retrained using the accumulated corrective data (e.g., supervised fine-tuning or preference learning pairs) to improve future response accuracy and reduce intervention rates. Resulting performance changes are surfaced via metrics of intervention frequency and types on the monitoring dashboard and may further inform dynamic threshold adjustments going forward.

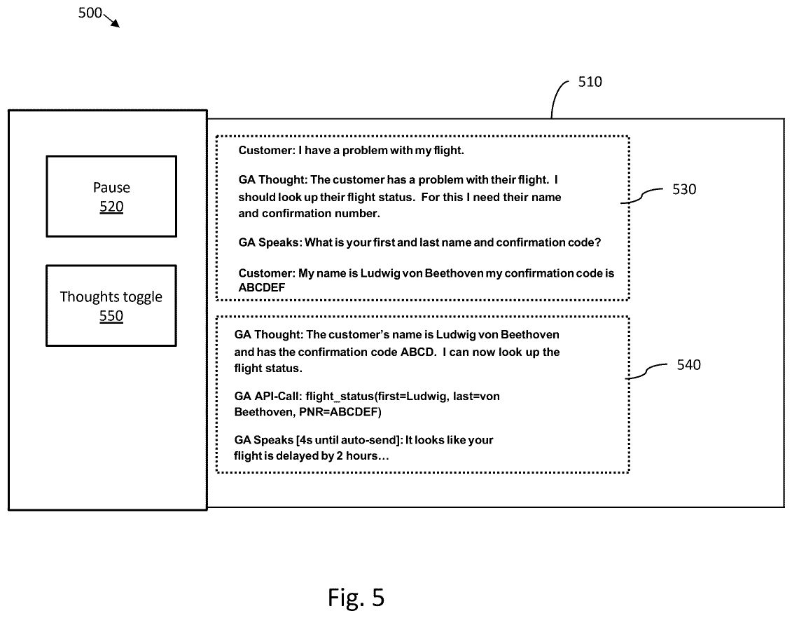

FIG. 5 illustrates aspects of an example conversation console 500 (i.e., a user interface) that may include an intervention interface 510. The conversation console 500 may render each session as an event timeline composed of elements, including GA “thoughts” or intermediate rationales, GA utterances intended for the customer, and GA-initiated service actions represented as structured API calls with parameters and responses.

The console exposes a pause control 520 that, when activated by the CSR, temporarily halts outward transmission of pending GA outputs and execution of pending API calls, thereby placing the session into an editable state. While paused, timeline items that have not yet been presented to the customer are mutable; timeline items already presented to the customer are frozen and rendered read-only to prevent retroactive alteration of visible history. In certain embodiments, the console 500 may automatically pause a conversation independent of manual activation of the pause control 520 when a computed metric associated with a pending output meets a configurable intervention condition. By way of example, the system may compute a response-quality score and/or an intervention-likelihood score for a GA pre-response or pending API call, and, upon determining that the score fails to satisfy a threshold (which may be dynamically adjusted based on system resource availability, human-agent availability, or conversation-urgency indicators), the console may automatically halt outward transmission of the pending GA output and defers execution of the pending API call. In response, the flagged items may be visually emphasized in the interface and placed into an editable state consistent with the pause semantics described above. A classifier, trained from historical logs of CSR interventions, emits an intervention likelihood score per turn; the console surfaces this as a safety indicator (e.g., color coding, badges) and may auto-pause the conversation when a threshold is exceeded (for example, prior to a high-risk API call such as a financial charge).

In one example, the intervention interface 510 may present a past conversations pane 530 and a frozen response pane 540. In some embodiments, the past conversations pane 530 may surface historical sessions associated with the same customer identifier, account, or intent class, and may provide search and filtering controls (e.g., by topic, tool usage, policy tag, or escalation outcome) to retrieve relevant excerpts. Retrieved items may include timestamped turns, prior human interventions, tool/API invocations, and outcome annotations, any of which may be previewed and, where appropriate, copied into a working draft to inform the present intervention. The pane 530 may further display per-session metrics (e.g., response quality scores, intervention frequency, and critical/non-critical flags) and may redact sensitive fields according to role-based access rules to maintain privacy and compliance. The frozen response pane 540 may render the generative agent's pending or already-presented output that has been placed in a read-only state by a pause (manual or automatic) so as to prevent retroactive alteration of visible history. In some embodiments, pane 540 may show the GA's machine-readable output alongside a human-readable translation, the contemplated tool/API call and parameters, confidence or policy compliance indicators, and a token- or field-level diff view that contrasts the GA's candidate with any proposed replacement prepared by the human agent. The pane 540 may also include fields for recording a reason code and contextual notes for the intervention, links to policy guidance, and controls to spawn a counterfactual branch or export the corrective data to a training queue, while preserving the immutability of customer-visible content.

In embodiments, the interface 510 may constrain the CSR interventions to the same mechanisms available to the GA. For example, if the CSR determines that a different action should be taken, the CSR issues that action by selecting the same API endpoint in an action panel, supplying parameters through validated fields, and submitting via the identical invocation pathway used by the GA. Likewise, if a customer-facing message requires correction, the CSR edits the pending utterance within a draft message editor bound to the GA output, rather than injecting an out-of-band message. This “same-rails” constraint ensures uniform logs, enables preference-pair construction (original GA output vs. CSR-corrected output), and supports downstream training.

The console may optionally expose a display thoughts toggle 550 that shows or hides the GA's intermediate reasoning tokens (e.g., proposed plan, tool selection rationale) to reduce cognitive load for the CSR while providing deep visibility for expert users. When thoughts are displayed, they are treated as pre-commit diagnostics and may be edited or overridden prior to emission of a corresponding utterance or action.

In certain embodiments, feedback provided by a CSR during a supervised or semi-supervised customer support session may be captured and utilized to refine the operation of a generative agent and/or the score classifier. As a generative agent interacts with a customer, the CSR may review the agent's proposed responses and either (i) allow the response to proceed without modification, (ii) correct the response prior to delivery, or (iii) override the response entirely with an alternative communication. Each of these actions may be logged and associated with the specific conversational context in which the action occurred.

The feedback data collected from CSR intervention may be processed into structured training examples. For example, an unmodified utterance that proceeds directly to the customer may be tagged as a positive instance, thereby reinforcing that the model's original output was appropriate. Conversely, a corrected utterance may produce a paired training instance consisting of the original, unaccepted output and the corrected, CSR-approved output. This pair constitutes a preference signal, which may be used in a supervised fine-tuning process or reinforcement learning framework to bias the model toward producing CSR-preferred outputs in future interactions.

In some implementations, CSR feedback may also be aggregated to generate signals and/or statistics concerning model reliability. For instance, the system may record the frequency of CSR interventions within a session, the distribution of corrections across different types of requests, and the contextual triggers that most often require human oversight. These aggregated metrics may be applied to train a classifier that predicts the likelihood of CSR intervention for a given prompt. The classifier may then be integrated into the generative agent workflow to selectively escalate high-risk responses for human review while allowing low-risk responses to proceed autonomously.

In various embodiments, counterfactual data may be generated and utilized to improve the performance of generative agents. Counterfactual data refers to alternative conversational paths or outcomes that did not occur in the original session, but which are synthesized or simulated in response to a human intervention or correction. For example, during a customer support interaction, a generative agent may produce an erroneous utterance. A human supervisor may intervene to correct the utterance, thereby creating a branching point in the conversation. From this branching point, a simulator may be employed to generate a hypothetical continuation of the dialogue that reflects the corrected utterance rather than the original erroneous one. The resulting conversation represents a counterfactual trajectory, illustrating how the session would have unfolded had the corrected utterance been delivered in real time.

As used herein, a customer simulator may be understood as a model or system configured to emulate the behavior of a user or customer interacting with a generative agent. The simulator may generate synthetic conversational turns, responses, or feedback signals conditioned on prior dialogue context, policy constraints, or observed behavioral patterns from historical data. In some embodiments, the customer simulator may utilize a generative language model, a sequence-to-sequence architecture, or a reinforcement learning framework trained on past customer interactions to approximate realistic dialogue flows. The simulator may be parameterized to reflect specific customer personas, sentiment profiles, or domain contexts, enabling the system to explore a wide range of hypothetical outcomes and error recovery scenarios. In one example, the simulator may include one or more of the systems, methods, and/or apparatuses disclosed in U.S. Pat. No. 12,282,744, issued on Apr. 22, 2025, and entitled “STATISTICAL LANGUAGE MODELS FOR SIMULATING COMMUNICATION SESSIONS,” which is hereby incorporated by reference for all purposes.

Counterfactual data provides several advantages over conventional training data. First, it enables the system to preserve and repurpose long conversations that might otherwise be truncated following an early intervention, ensuring that corrections at multiple points in the dialogue may be captured and exploited for training purposes. Second, counterfactual data incorporates both the actual conversational history and the hypothetical corrected path, thereby producing richer training pairs. These pairs may include the original utterance and the corrected utterance, together with their respective downstream conversational contexts. Such paired data enables supervised preference learning, reinforcement learning from human feedback, and the construction of classifiers that predict when a human agent would be likely to intervene.

By incorporating counterfactual data into the training, the system may enhance the reliability of generative agents under real-world operating conditions. Unlike static pre-deployment datasets, counterfactual trajectories explicitly capture dynamic branching behaviors, contextual corrections, and intervention-trigger patterns that arise during live interactions. As a result, counterfactual data improves both the precision of generative agent outputs and the system's ability to autonomously handle future interactions while minimizing the need for human oversight.

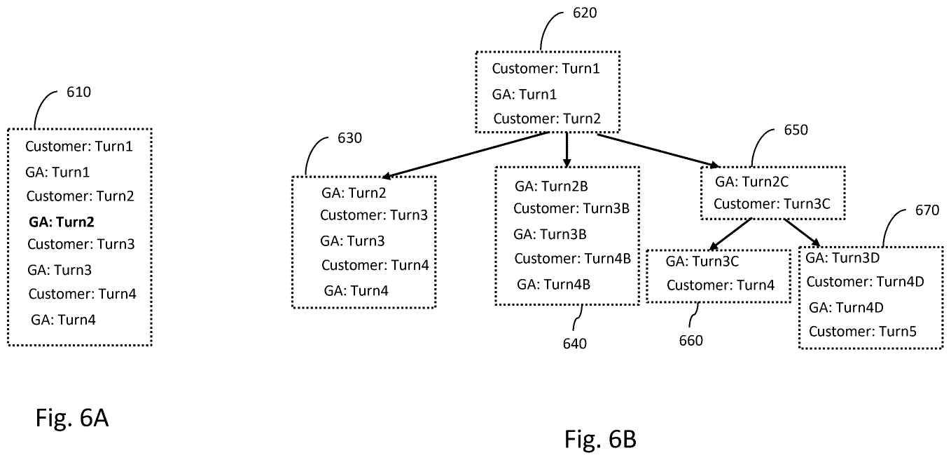

FIGS. 6A and 6B depict aspects of generating counterfactual examples from saved conversations. FIG. 6A depicts an example saved conversation that may be used to generate a number of training examples. The conversation 610 may be between any number of customers, CSRs, models, agents, and/or other users. For the purposes of clarity, the conversation 610 is between a customer and a GA. The conversation may include multiple turns (e.g., turn1, turn2, etc.). The conversation may be analyzed using a classifier to identify a turn in the conversation from a GA with a low score.

FIG. 6A depicts an example saved conversation 610 that may be used to generate multiple training examples. The conversation 610 is represented as an ordered sequence of turns (turn1, turn2, etc.) exchanged between a customer and a GA for clarity of illustration, although in other embodiments, any number of customers, CSRs, models, agents, and/or other users may participate. Each user turn may include the raw utterance, channel and timestamp metadata, and optional policy/intent tags. Each GA turn may include one or more pre-responses (e.g., draft utterances, planned tool/API calls with parameters, intermediate rationales), a committed utterance that was presented to the customer (if any), tool/API invocation records and results, and/or session context (e.g., retrieval citations, account tier, topic sensitivity, and urgency indicators).

A classifier may be used to analyze the conversation 610 to identify one or more GA turns with a low-quality score (i.e., “GA:Turn2”). In one example, a scoring module computes a response-quality score for each GA turn using features such as factuality/grounding consistency, policy compliance, tool-parameter validity, and contextual coherence. A context-aware threshold may then be applied that may be dynamically adjusted based on conversation factors (e.g., user account priority, urgency indicators, topic sensitivity). When a score fails to satisfy the current threshold, the corresponding GA turn is flagged and optionally categorized into an error type, such as contextual misunderstanding, incorrect factual information, or inappropriate tone. The flagged turn may be visually emphasized in an intervention interface and because the saved record includes pre-responses.

A counterfactual tree rooted at the flagged turn may be generated by substituting the flagged response for the GA's original output and then simulating alternative GA responses and user responses. FIG. 6B shows one example of a possible tree that may be generated. FIG. 6A shows a conversation tree generated from the original conversation 610. The tree includes four different branches that diverge from the root 620. The different branches may correspond to alternative turn2 replies from the GA (e.g., turn 2B, turn2C, etc.). The alternative replies may be human-generated or generated by a model (e.g., a customer simulator as described herein).

A customer simulator, trained on historical conversation data, may produce set of plausible replies (e.g., top-kk samples), creating child nodes that the GA (or a policy-constrained planner) advances with next actions. Each branch is rolled forward to termination criteria (e.g., resolution, escalation, abandonment) and evaluated using success metrics such as task completion rate and proxy user-satisfaction score. The branches may be weighted according to their likelihood of improving future GA behavior and incorporated into the training corpus alongside the original flag and the human-modified response.

From the counterfactual training tree, the training examples may be generated in several forms. In one example, a preference pair may be formed by linking the GA's original output to a human-modified response (if available from a live or offline edit), together with a context window (preceding user and GA turns, tool results) and intervention metadata (e.g., timestamp and reason code). In another example, contrastive examples may be constructed by pairing successful vs. unsuccessful continuations taken from the same conversation, highlighting the change that resolves the error (e.g., corrected parameter in a tool call, corrected fact in an utterance). In another example, positive examples may be extracted from unflagged GA turns that exceeded the threshold, providing reinforcement signals for correct behavior. Each example may be annotated with the error category, source turn identifier, and weight (e.g., based on downstream success metrics or expected utility).

The training corpus assembled from the counterfactual branches may be normalized into model-readable examples.

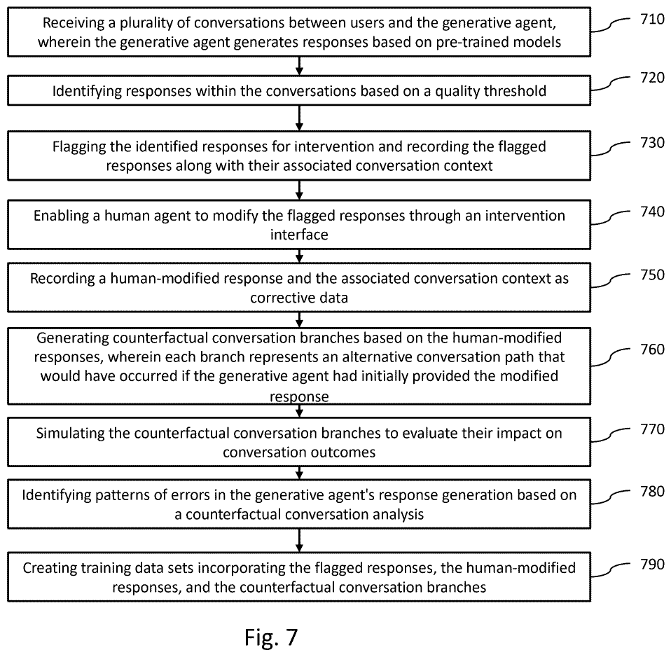

FIG. 7 illustrates a flowchart of an example method for improving performance of a GA through counterfactual data collection and analysis.

At Step 710 the method may include receiving and ingesting a plurality of conversations between users and the GA, which produces responses using one or more pre-trained models. In embodiments, the conversations may be grouped into sessions and normalized to include user and agent turns, any intermediate GA pre-responses (e.g., drafts, tool rationales), tool/API invocations with parameters and results, and session metadata (timestamps, channel, account tier, topic).

At Step 720, each GA response may be analyzed to compute a response-quality score (using, for example, a classifier) reflecting factors such as factuality, policy compliance, parameter validity, and contextual coherence. A dynamic quality threshold is then set for the response by incorporating conversation-context factors, including user account priority level, conversation-urgency indicators, and topic-sensitivity classification; this produces a context-aware flagging criterion that adapts in real time (claim 208).

At Step 730, responses whose scores fail to satisfy the current threshold may be identified for intervention. Each identified response is categorized into an error type (e.g., contextual misunderstanding, incorrect factual information, or inappropriate tone) to guide downstream handling and analytics. Categorization may use rule-based checks and learned classifiers, and can attach multiple labels when issues co-occur. At Step 730, the identified responses are flagged and recorded together with the surrounding conversation context (e.g., preceding user turns, relevant GA pre-responses, pending/executed API calls). The system also stores corrective metadata, including a reason for intervention, a timestamp of the intervention trigger, and the conversation context snapshot (claim 206). This creates a traceable, auditable unit suitable for training and evaluation.

At Step 740, the method may include presenting an intervention interface that exposes the flagged turn, its error type(s), and the recorded context. The interface allows the human agent to operate on the conversation (e.g., propose/edit tool calls, change parameters) and may suggest candidate fixes. The agent can edit a pending GA utterance or tool call prior to emission, then confirm the correction.

At Step 750, the method may include recording a corrective record linking the original flagged response, the human-modified response, the context snapshot, and the intervention metadata (e.g., reason code, timestamp).

At Step 760, the method may create one or more counterfactual conversation branches by substituting the human-modified response at the flagged turn and simulating alternative user responses conditioned on that modified GA response. In embodiments, branches may be produced using a customer simulator that replicates user behavior from historical conversation data. In embodiments, the customer simulator may be the GA or a different generative model or system. Sampling controls (e.g., temperature, top-k, policy constraints) and a branching budget determine how many plausible continuations/counterfactuals are explored.

At Step 770, each counterfactual branch is rolled forward under the simulator to a termination criterion (e.g., resolution, escalation, user exit). The system computes success metrics, including at least a user satisfaction score (e.g., proxy via sentiment/CSAT models) and task-completion rate. Additional metrics may include steps-to-resolution, tool-error counts, and policy-risk reduction. In some embodiments, at Step 780, the method may include assigning a weight to each branch reflecting its likelihood of improving future GA responses. Weights may combine observed success metrics, confidence intervals, and priors on scenario frequency.

At Step 780, the method may include aggregating counterfactual analyses to identify patterns of errors by type, trigger context, topic, and tool usage, including how specific corrections alter downstream outcomes. A dashboard presents aggregated metrics (e.g., error frequency by type, success rates per correction pattern, and weighted expected utility).

At Step 790, the method may include creating training datasets that include (i) flagged responses, (ii) human-modified responses, and (iii) counterfactual branches. The data may be organized into contrastive examples that highlight differences between successful and unsuccessful paths (e.g., tuples pairing original vs. modified turn plus divergent continuations, labeled with error types, success metrics, and branch weights).

In embodiments, the training datasets may be used to periodically retrain the GA using the constructed datasets to improve response generation accuracy and reduce intervention frequency. Post-retraining, a dashboard may be used to update live performance indicators.

As described herein, machine learning models may be trained using supervised learning, unsupervised learning, or hybrid learning techniques. In supervised learning, a model is generated using a set of labeled examples, where each example has corresponding target label(s). In unsupervised learning, the model is generated using unlabeled examples. The collection of examples constructs a dataset, usually referred to as a training dataset. During training, a model is generated using this training data to learn the relationship between examples in the dataset. In the context of generative agents, unsupervised learning often encompasses pre-training of large language models (LLMs) or other auto-regressive models on unlabeled corpora to learn general-purpose sequence representations and probabilistic next-token prediction patterns. Auto-regressive architectures, including transformer-based language models, recurrent sequence models, and related variants, may serve as components for the generative agents described herein. In addition to auto-regressive models, other unsupervised or self-supervised generative approaches may be employed, including diffusion models, masked-token models, and variational or denoising autoencoders, which can generate or reconstruct multimodal content such as text, images, or audio.

Supervised learning techniques may subsequently be applied to specialize or align such models with task-specific or domain-specific objectives (for example, customer interaction patterns, compliance policies, or sentiment guidelines). Hybrid approaches, such as reinforcement learning from human feedback (RLHF) or preference-pair optimization, may further refine the model's generative behavior to align with desired outcomes.

The training process may include various phases such as: data collection, preprocessing, feature extraction, model training, model evaluation, and model fine-tuning. The data collection phase may include collecting a representative dataset, typically from multiple users, that covers the range of possible scenarios and positions. The preprocessing phase may include cleaning and preparing the examples in the dataset and may include filtering, normalization, and segmentation. The feature extraction phase may include extracting relevant features from examples to capture relevant information for the task. The model training phase may include training a machine learning model on the preprocessed and feature-extracted data. Models may include support vector machines (SVMs), artificial neural networks (ANNs), decision trees, and the like for supervised learning, or autoencoders, Hopfield, restricted Boltzmann machine (RBM), deep belief, Generative Adversarial Networks (GAN), or other networks, or clustering for unsupervised learning. The model evaluation phase may include evaluating the performance of the trained model on a separate validation dataset to ensure that it generalizes well to new and unseen examples. The model fine-tuning may include refining a model by adjusting its parameters, changing the features used, or using a different machine-learning algorithm, based on the results of the evaluation. The process may be iterated until the performance of the model on the validation dataset is satisfactory and the trained model can then be used to make predictions.

In embodiments, trained models may be periodically fine-tuned for specific user groups, applications, and/or tasks. Fine-tuning of an existing model may improve the performance of the model for an application while avoiding completely retraining the model for the application.

In embodiments, fine-tuning a machine learning model may involve adjusting its hyperparameters or architecture to improve its performance for a particular user group or application. The process of fine-tuning may be performed after initial training and evaluation of the model, and it can involve one or more hyperparameter tuning and architectural methods.

Hyperparameter tuning includes adjusting the values of the model's hyperparameters, such as learning rate, regularization strength, or the number of hidden units. This can be done using methods such as grid search, random search, or Bayesian optimization. Architecture modification may include modifying the structure of the model, such as adding or removing layers, changing the activation functions, or altering the connections between neurons, to improve its performance.

Online training of machine learning models includes a process of updating the model as new examples become available, allowing it to adapt to changes in the data distribution over time. In online training, the model is trained incrementally as new data becomes available, allowing it to adapt to changes in the data distribution over time. Online training can also be useful for user groups that have changing usage habits of the stimulation device, allowing the models to be updated in almost real-time.

In embodiments, online training may include adaptive filtering. In adaptive filtering, a machine learning model is trained online to learn the underlying structure of the new examples and remove noise or artifacts from the examples.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor, or any variant such as a co-processor (math co-processor, graphic co-processor, communication co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions, and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions, or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor, and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM, and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

All documents referenced herein are hereby incorporated by reference in their entirety.

What is claimed is:

1. A method for improving performance of a generative agent during live interactions, the method comprising:
monitoring a conversation between a user and the generative agent, wherein the generative agent generates responses based on pre-trained models;
analyzing a first response generated by the generative agent to determine a first response quality score;
automatically flagging the first response for human intervention based on a quality score threshold;
pausing the conversation upon flagging the first response for intervention, wherein the pause prevents the flagged response from being presented to the user;
enabling a human agent to modify the flagged response through an intervention interface, wherein the intervention interface allows the human agent to act as the generative agent by interacting with tools accessible to the generative agent;
updating the conversation with the modified response generated by the human agent;
resuming the conversation after the modified response is presented to the user; and
recording the flagged response, the human intervention, and the modified response as corrective data for training the generative agent to improve future response generation.

2. The method of claim 1, wherein the intervention interface visually distinguishes flagged responses for intervention from other responses with visual emphasis.

3. The method of claim 1, further comprising dynamically adjusting the response quality score threshold based on at least one of: system resource availability, human agent availability, or conversation urgency indicators.

4. The method of claim 1, wherein the flagged response includes pre-responses generated by the generative agent, and the human agent is enabled to modify the pre-responses before they result in customer-facing actions.

5. The method of claim 1, further comprising categorizing flagged responses into critical and non-critical types, wherein critical responses are prioritized for intervention under high-load conditions.

6. The method of claim 1, wherein the corrective data recorded includes metadata describing a reason for the human intervention and a context of the conversation.

7. The method of claim 1, further comprising presenting metrics of intervention frequency and types to a dashboard for monitoring the generative agent's performance over time.

8. The method of claim 1, wherein the intervention interface translates machine-readable outputs into human-readable formats to facilitate human agent interaction.

9. The method of claim 1, further comprising enabling the human agent to initiate API calls through the intervention interface, wherein the API calls are formatted to match a syntax used by the generative agent.

10. The method of claim 1, wherein the generative agent is retrained periodically using the corrective data recorded from human interventions to improve response generation accuracy.

11. The method of claim 1, further comprising:
monitoring multiple conversations between users and the generative agent;
analyzing performance metrics across the monitored conversations, including
intervention frequency, response quality scores, and types of flagged responses; and
dynamically updating a graphical display to present aggregated performance metrics.

12. The method of claim 1, wherein the intervention interface provides real-time suggestions to the human agent for modifying flagged responses.

13. A system, comprising at least one server computer comprising at least one processor and at least one memory, the at least one server computer configured to:
monitor a conversation between a user and a generative agent, wherein the generative agent generates responses based on pre-trained models;
analyze a first response generated by the generative agent to determine a first response quality score;
automatically flag the first response for human intervention based on a quality score threshold;
pause the conversation upon flagging the first response for intervention, wherein the pause prevents the flagged response from being presented to the user;
modify the flagged response through an intervention interface, wherein the intervention interface allows the human agent to act as the generative agent by interacting with tools accessible to the generative agent;
update the conversation with the modified response generated by the human agent;
resume the conversation after the modified response is presented to the user; and
record the flagged response, the human intervention, and the modified response as corrective data for training the generative agent to improve future response generation.

14. One or more non-transitory, computer-readable media comprising computer-executable instructions that, when executed, cause at least one processor to perform actions comprising:
monitoring a conversation between a user and a generative agent, wherein the generative agent generates responses based on pre-trained models;
analyzing a first response generated by the generative agent to determine a first response quality score;
automatically flagging the first response for human intervention based on a quality score threshold;
pausing the conversation upon flagging the first response for intervention, wherein the pause prevents the flagged response from being presented to the user;
enabling a human agent to modify the flagged response through an intervention interface, wherein the intervention interface allows the human agent to act as the generative agent by interacting with tools accessible to the generative agent;
updating the conversation with the modified response generated by the human agent;
resuming the conversation after the modified response is presented to the user; and
recording the flagged response, the human intervention, and the modified response as corrective data for training the generative agent to improve future response generation.

15. A method for improving performance of a generative agent through counterfactual data collection, the method comprising:
receiving a plurality of conversations between users and the generative agent, wherein the generative agent generates responses based on pre-trained models;
identifying responses within the conversations based on a quality threshold;
flagging the identified responses for intervention and recording the flagged responses along with their associated conversation context;
enabling a human agent to modify the flagged responses through an intervention interface;
recording a human-modified response and the associated conversation context as corrective data;
generating counterfactual conversation branches based on the human-modified responses, wherein each branch represents an alternative conversation path that would have occurred if the generative agent had initially provided the modified response;
simulating the counterfactual conversation branches to evaluate their impact on conversation outcomes;
identifying patterns of errors in the generative agent's response generation based on a counterfactual conversation analysis; and
creating training data sets incorporating the flagged responses, the human-modified responses, and the counterfactual conversation branches.

16. The method of claim 15, wherein the counterfactual conversation branches are generated by simulating alternative user responses based on the modified generative agent responses.

17. The method of claim 15, further comprising categorizing the flagged responses and counterfactual conversation branches into error types, wherein the error types include at least one of contextual misunderstanding, incorrect factual information, or inappropriate tone.

18. The method of claim 15, wherein the simulation of counterfactual conversation branches includes evaluating conversation outcomes using a success metric, wherein the success metric includes at least one of a user satisfaction score or task completion rate.

19. The method of claim 15, further comprising weighting the counterfactual conversation branches based on their likelihood of improving future generative agent responses.

20. The method of claim 15, wherein the corrective data recorded includes metadata describing a reason for the human intervention, a timestamp of the intervention, and a conversation context.

21. The method of claim 15, further comprising presenting aggregated metrics of counterfactual conversation analysis, including error frequency and success rates, to a dashboard for monitoring generative agent performance.

22. The method of claim 15, further comprising dynamically adjusting the quality threshold for flagging responses based on conversation context factors, including user account priority level, conversation urgency indicators, or topic sensitivity classification.

23. The method of claim 15, wherein the counterfactual conversation branches are used to generate contrastive examples for training the generative agent, highlighting differences between successful and unsuccessful conversation paths.

24. The method of claim 15, further comprising retraining the generative agent periodically using the training data sets created from flagged responses, human-modified responses, and counterfactual conversation branches.

25. The method of claim 15, wherein the counterfactual conversation branches are generated using a customer simulator that replicates user behavior based on historical conversation data.

26. A system, comprising at least one server computer comprising at least one processor and at least one memory, the at least one server computer configured to:
receive a plurality of conversations between users and a generative agent, wherein the generative agent generates responses based on pre-trained models;
identify responses within the conversations based on a quality threshold;
flag the identified responses for intervention and recording the flagged responses along with their associated conversation context;
modify the flagged responses through an intervention interface;
record a human-modified response and the associated conversation context as corrective data;
generate counterfactual conversation branches based on the human-modified responses, wherein each branch represents an alternative conversation path that would have occurred if the generative agent had initially provided the modified response;
simulate the counterfactual conversation branches to evaluate their impact on conversation outcomes;
identify patterns of errors in the generative agent's response generation based on a counterfactual conversation analysis; and
create training data sets incorporating the flagged responses, the human-modified responses, and the counterfactual conversation branches.

27. One or more non-transitory, computer-readable media comprising computer-executable instructions that, when executed, cause at least one processor to perform actions comprising:
receiving a plurality of conversations between users and a generative agent, wherein the generative agent generates responses based on pre-trained models;
identifying responses within the conversations based on a quality threshold;
flagging the identified responses for intervention and recording the flagged responses along with their associated conversation context;
enabling a human agent to modify the flagged responses through an intervention interface;
recording a human-modified response and the associated conversation context as corrective data;
generating counterfactual conversation branches based on the human-modified responses, wherein each branch represents an alternative conversation path that would have occurred if the generative agent had initially provided the modified response;
simulating the counterfactual conversation branches to evaluate their impact on conversation outcomes;
identifying patterns of errors in the generative agent's response generation based on a counterfactual conversation analysis; and
creating training data sets incorporating the flagged responses, the human-modified responses, and the counterfactual conversation branches.
